(19) United States
(12) Patent Application Publication
(10) Pub. No.: US 2012/0045294 A1
(43) Pub. Date: Feb. 23, 2012

(54) METHOD AND DEVICE FOR CASING A BOOK BLOCK IN A BOOK COVER

(75) Inventor: Thomas FRIESE, Leipzig (DE)

(73) Assignee: MULLER MARTINI HOLDING AG, Hergiswil (CH)

(21) Appl. No.: 13/213,541

(22) Filed: Aug. 19, 2011

(30) Foreign Application Priority Data
Aug. 23, 2010 (CH) 01349/10

(51) Int. Cl. B42C 11/04

(52) U.S. Cl. 412/5; 412/21

(57) ABSTRACT

A method and a device for casing a book block in a book cover, in which the book block is supplied to a casing-in machine in a first feed direction, taken over by the casing-in machine from a saddle plate of an endless conveyor, and glued as it is transported on the saddle plate. The book covers are supplied in a second feed direction. The book block is supplied to the casing-in machine in a feed direction different from the second feed direction of the book cover. In a first step, the book block is handed over from a first feeder to a transfer device located in a first, upstream position, is transported in a second step from the first position to a second, downstream position of the transfer device, and, in a third step, is picked up by the saddle plate from the second position of the transfer device.

### CROSS-REFERENCE TO RELATED APPLICATIONS

The present application claims priority of CH 01349/10, filed Aug. 23, 2010, the priority of this application is hereby claimed and this application is incorporated herein by reference.

### BACKGROUND OF THE INVENTION

The invention pertains to a method for casing a book block in a book cover and to a device for implementing the method.

Hardcover books are produced today in most cases on book lines, in which a so-called casing-in machine is used to assemble appropriately prepared book blocks and book covers to obtain the finished books, that is, to case the book blocks in their assigned book covers. The casing-in machine often forms only one of the work stations of the book line, which for its own part comprises a general production direction, from which the feed direction for the book blocks and/or for the book covers to the casing-in machine can deviate. Casing-in machines designed as independent units arranged separately from the book line are also known.

Casing-in machines with endless conveyors working according to the “paternoster” elevator principle with interconnected vertical and horizontal conveying sections are known from CH 692384 A5 and EP 1780038 A1. The book blocks and book covers, which arrive from the same direction, are supplied to these casing-in machines and are then transported by saddle plates mounted on an endless conveyor. Because of their high productivity, especially the endless conveyors in which the saddle of the saddle plate always faces upward and the upper edge is always oriented horizontally have become widely adopted. This is achieved in that, for example, so-called saddle plate carriers driven by chains are always kept in an exactly vertical position by means of a control chain or control cam. Ensuring the precision of movement of the saddle plates required for casing-in with the exact registration involves a very large amount of engineering effort. The longer the distance traveled by the endless conveyor per circuit, the greater the corresponding effort.

The vertical conveying sections of the endless conveyor are used for the processing steps. First, a first feeder supplies the book block, which has previously been opened in the middle, and makes it available with the precise registration in a first horizontal plane to a vertical conveying section of the endless conveyor, which faces the feeder. The saddle plates of the endless conveyor introduce themselves from below into the book blocks being provided in this way and pick them up in the first horizontal plane. In following steps, the book blocks, which are now being conveyed vertically upward, are glued on their outer surfaces and then pass through a second horizontal plane of the endless conveyor, in which they are made available to the book covers being supplied by a second feeder. Finally, the book covers are also picked up by cover holding and pressing devices, placed on the book block in question, and pressed onto it. What is used for this purpose is the remaining vertical conveying section of the endless conveyor up to the point at which it reverses direction and starts to move downward again. During the downward movement on the vertical conveying section of the endless conveyor facing away from the feeders, the book which has been completed in the manner described above is usually removed from the saddle plate by stationary elements and in most cases carried away from the endless conveyor to one side, with the spine facing forward, in a third horizontal plane. The empty saddle plates then reverse direction again, so that the first vertical conveying section can pick up the next book block from underneath.

The product formats normally processed require that the vertical conveying sections of the endless conveyor be relatively long. Because the saddle plates, during their upward and downward movement, pass through the horizontal planes in which the book blocks and book covers are fed in, these blocks and covers must be fed to the endless conveyor from appropriate directions. Even in cases where the point at which the conveyor reverses direction is close to the floor, therefore, the result is that tall, tower-like structures are obtained, which are highly complicated and expensive. On the other hand, the processes required to prepare the book blocks and book covers suffer from space limitations and unfavorable ergonomic relationships.

In addition, access to the book block is highly limited in certain areas by the cover-feeding process taking place above it. There are also limitations with respect to the cover-feeding process itself. The space available in the area of the first horizontal plane of the endless conveyor is occupied by the feeder for the book blocks. The processing stations must therefore be highly compact in design. Platforms are usually required to create ergonomically favorable conditions in the cover-feeding area.

Casing-in machines to which the book blocks and the book covers are fed from different directions are also known (compare the “three-wing horizontal principle” in Liebau, Industrielle Buchbinderei [Industrial Bookbinding], 1997, pp. 428-429, ISBN 3-88013-553-3). A machine of this type has several saddle plates distributed around a circle on a horizontally rotating rotor. For the various work steps, the saddle plates are moved vertically up or down in their positions during the times that the rotor is stationary. Because of the circumstances present here, an endless conveyor operating on the paternoster principle cannot be used. The output of machines of this type is very limited.

### SUMMARY OF THE INVENTION

The goal of the invention is to create a method and a device for casing a book block in a book cover which, while offering high productivity, also makes it possible to arrive at a compact arrangement of the various processing units without significant limitations associated with the feeding of the book blocks and book covers.

According to the general method in question, the book block is first supplied in a first feed direction with its spine facing upward and oriented horizontally to a casing-in machine and then transferred to the casing-in machine by a saddle plate with an upward-facing, horizontally oriented spine. Then the book block being transported on the saddle plate is glued, and a book cover is supplied to the casing-in machine in a second feed direction. The subsequent casing of the book block in the book cover takes place while the spine of the saddle plate is being kept horizontal. According to the invention, the book block is supplied to the casing-in machine in a first feed direction which is different from the second feed direction, i.e., from the direction in which the book covers are supplied; in particular, the first feed direction is opposite to the second, book cover-feed direction. In a first step, the book block is transferred by a first feeder to a transfer device located in a first, upstream position; in a second step, it is transported from the first position into a second, downstream position of the transfer device; and, in a third step, it is picked up from the second position of the transfer device by the saddle plate of the endless conveyor.

As a result of the arrangement of the transfer device with its second position a certain distance away from the first position, the transport of the book blocks on the saddle plates of the endless conveyor and thus also the casing-in of the book blocks into the book covers are advantageously disconnected from the feed of the book blocks. Thus book blocks and book covers can be supplied to the endless conveyor from different directions. In addition, free spaces for the work processes performed on the book blocks and book covers are also created. The method, furthermore, makes it possible to remove book blocks easily from the line if necessary by not supplying them to the endless conveyor.

In an advantageous embodiment of the method, the area where the book blocks are transported to the frost, upstream position of the transfer device is located underneath the endless conveyor. As a result, the drive chains of the endless conveyor pass exclusively above the area where the book blocks are supplied and thus can be much shorter than those according to the known solutions.

In another advantageous embodiment of the method, the book block, as it is being transported from the first, upstream position into the second, downstream position, of the transfer device, is lifted, especially lifted vertically, and aligned before it is lifted. This process step of lifting the book block represents a simpler and lower-cost way to feed the book block to the casing-in machine.

In a next advantageous embodiment of the method, the book block is transported in the opened state from the first upstream position to the second, downstream position of the transfer device. Then the saddle plate is introduced from the side and at least approximately horizontally into the opened book block located in the second position and picks it up with an at least approximately vertical movement. Because the saddle plate is introduced at least approximately horizontally into the book block, there is, advantageously, no crossing of the supplied book block with the endless conveyor i.e. their paths do not cross.

According to another advantageous embodiment of the method, the saddle plate of the endless conveyor is moved around a circuit according to the paternoster principle. In this way, the book blocks can be introduced into the book covers with a high level of productivity.

A device of the general type in question for casing a book block in a book cover has an endless conveyor with at least one saddle plate, on which the book block is cased in the book cover. The at least one saddle plate comprises an upward-facing, horizontally oriented spine, and the book block can be supplied with its spine facing upward and horizontally oriented to the casing-in machine by a first feeder in a first feed direction. The book cover can be supplied to the casing-in machine by a second feeder in a second feed direction.

According to the invention, the first feed direction differs from the second feed direction, and in particular it is opposite to the second feed direction. In addition, the casing-in machine comprises a transfer device arranged between the first feeder and the endless conveyor. The transfer device has a first upstream position for accepting the book block from the first feeder and a second, downstream position for handing the book block over to the endless conveyor.

As a result of the arrangement of the transfer device between the first feeder and the endless conveyor, the latter is disconnected from the process of supplying the book blocks. In addition, two different positions a certain distance away from each other are created for the transfer device. Book blocks can thus be advantageously supplied to the casing-in machine from any direction, which means in a direction different from that in which the book covers are fed.

In another advantageous embodiment, the transfer device is designed to be switchable so that it can be stopped and restarted. As a result, the transfer device can be switched off when needed, so that no book blocks are supplied to the casing-in machine.

In a next embodiment, the transfer device has a transfer element for picking up the book block from the first feeder; this element has a roof-like design open at the sides and top and comprises at least one aligning element and format-dependent support elements for the book block. After the book block has been aligned cleanly according to its format, the transfer element advantageously allows the saddle plates of the endless conveyor to introduce themselves into the book blocks without danger of collisions.

In another advantageous embodiment of the device, the first feeder is arranged underneath the endless conveyor, wherein the transfer element is designed to move vertically. Thus the endless conveyor is located completely above the area where book blocks are supplied, which, for approximately the same output and the same format specifications, leads to a reduction in the required number saddle plates and in the length of the chain. The reduced overall length of the endless conveyor is associated with corresponding cost savings for the casing-in machine.

According to the next advantageous embodiment of the device, an opening device for the book blocks is arranged in, on, or upstream of the first feeder. Thus the book blocks can always be moved in a defined position as they are transported by the components of the casing-in machine which engage in the opening.

In another advantageous embodiment of the device, the endless conveyor is designed with first and second vertical conveying sections and with upper and lower conveying sections, which connect the first and second vertical conveying sections to each other. The first vertical conveying section faces the transfer device, whereas the second vertical conveying section faces away from the transfer device. An endless conveyor of this type, which operates with high productivity, can be loaded advantageously from different directions by combining it with a transfer device, located between the first feeder and the endless conveyor, to transport the book block from a receiving position, in which it accepts the book block from the first feeder, to a transfer position, in which it transfers the book block to the endless conveyor. In cases where the endless conveyor is loaded from the side, additional free space can be created underneath the conveyor and used for other purposes, such as to reduce the construction height.

The endless conveyor, the first and second feeders, and the transfer device have their own separate drives, especially servo drives, wherein the drives are connected to each other. This provides an alternative solution, according to which the transfer of the book block and the book cover can be synchronized with the introduction of the saddle plate.

In another advantageous embodiment, the at least one saddle plate comprises a height which is less than the maximum height of the book block which can be processed by the casing-in machine and which corresponds in particular to approximately one-third of this height. This makes it possible to obtain a casing-in machine with a very compact design. The number of saddle plates on an endless conveyor of the type previously described can be decreased in comparison to a known endless conveyor without loss of output. Costs are therefore also reduced. An endless conveyor with shorter vertical distances also makes it possible to simplify the often complicated task of guiding the means used to convey the saddle plates. In cases where the book blocks are supplied underneath the endless conveyor, the additional advantage is obtained that the transfer element of the transfer device does not have to lift the book blocks as high.

The advantages cited above also pertain to a book line equipped with a device of this type. The method and the device also make it possible to supply book blocks and book covers independently of the direction in which the book line operates.

The various features of novelty which characterize the invention are pointed out with particularity in the claims annexed to and forming a part of the disclosure. For a better understanding of the invention, its operating advantages, specific objects attained by its use, reference should be had to descriptive matter in which there are described preferred embodiments of the invention.

### BRIEF DESCRIPTION OF THE DRAWING

In the drawing:

FIG. 1 shows a perspective view of an inventive device; and

FIG. 2 shows a side view of the device according to FIG. 1.

### DETAILED DESCRIPTION OF THE INVENTION

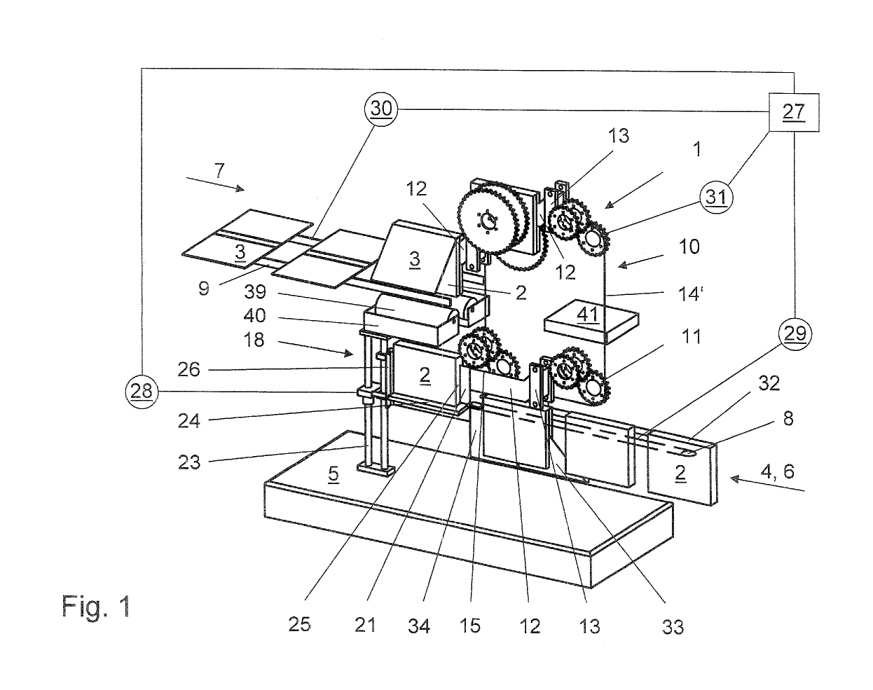

The figures show an inventive casing-in machine 1, which is provided to case a book block 2 in a book cover 3. It is designed as an independent work station, but it can also be integrated into a book line, through which the book block 2 passes in a production direction 4. In FIG. 1, a book line of this type is merely suggested by the arrow indicating its production direction 4. The casing-in machine 1 stands on a base 5 or is anchored in it. The book blocks are supplied from right to left, for example, that is, in a first feed direction 6 corresponding to the production direction 4, and the book covers 3 are supplied from left to right, for example, that is, in a second feed direction 7 proceeding opposite to the production direction 4. The book blocks 2 are transported to the casing-in machine 1 by a first feeder 8 designed as a chain conveyor. Alternatively, the first feeder device 8 can be designed as, for example, a book channel (not shown), in which the book blocks are transported in a standing position by drivers on a web. The book blocks can also be supplied by means of grippers or tongs (not shown). The hook covers 3 are supplied by a second feeder 9.

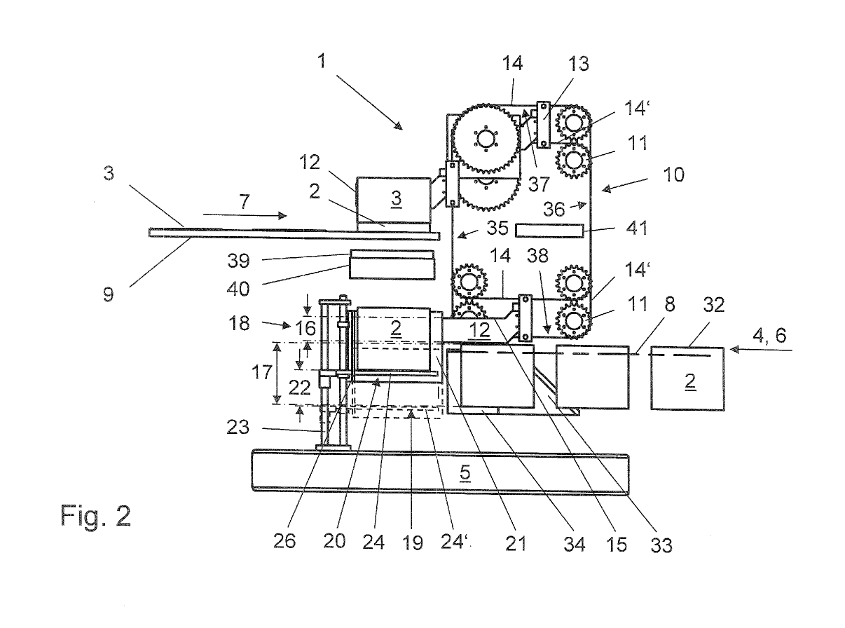

The casing-in machine 1 has an endless conveyor 10, which has saddle plates 12 traveling around a circuit by means of chain sprockets 11 in the manner of a paternoster elevator. Each saddle plate is attached by a saddle plate carrier 13 to a double drive chain 14. The saddle plate carriers 13 are also held in a vertical position at all times by a control chain 14′, so that the saddle plates 12 attached to the saddle plate carriers 13 are always in a horizontal position. For the sake of clarity, only the control chain 14 is shown in FIG. 1, whereas FIG. 2 shows both one chain of the double drive chain 14 and the control chain 14′. Each saddle plate is intended to hold one book block 2. For this purpose, each saddle plate 12 comprises an upper, horizontal spine 15. Proceeding from the spine 15, the saddle plate 12 extends downward over a height 16, which is equal to approximately one-third of the maximum height 17 of the book block 2 which the casing-in machine can process. During the operation of the endless conveyor 10, the saddle plates 12 travel in the clockwise direction, wherein they always remain above the book blocks 2 being conveyed by the first feeder 8. Of course, it is possible to equip the endless conveyor 10 not with the three saddle plates 12 as shown but with only a single saddle plate or with a number of saddle plates differing from three, but the use of several saddle plates makes it possible to take maximum advantage of the transport distance available and to achieve the highest possible processing speed.

Between the first feeder 8 and the endless conveyor 10 there is a transfer device 18, which has a first, upstream position 19 for accepting the book block 2 from the first feeder 8 and a second, downstream position 20 for handing over the book block 2 to the endless conveyor 10, that is, to its saddle plate 12.

Because of the way in which the transfer device 18 is designed with its first position 19 a certain distance away from its second position 20, the process of transporting the book blocks 2 on the saddle plates 12 of the endless conveyor 10 and thus also the process of casing the book blocks 2 in the book covers 3 are advantageously disconnected from the process of supplying the book blocks 2. In contrast to the feed direction 7 of the book covers 3, therefore, the book blocks 2 can be supplied to the casing-in machine 1 from below, from above, from the side, or even at an angle. The two positions 19, 20 of the transfer device 18 will therefore also be arranged differently with respect to each other in a corresponding manner.

In the exemplary embodiment shown here, the feed direction 6 for the book blocks 2 is opposite the feed direction 7 for the book covers 3, and the second position 20 of the transfer device 18 is above its first position 19. Accordingly, the book blocks 2 are supplied to the casing-in machine 1 by the first feeder in the area below the endless conveyor 10; that is, the book blocks 2 are supplied to the first, upstream position 19 of the transfer device 18 below the traveling saddle plates 12 of the endless conveyor 10. The book blocks 2 are transported parallel to the lower horizontal movement of the endless conveyor 10; that is, a book block 2 being conveyed by the first feeder 8 and the saddle plate 12 which will be picking up this block are each moved horizontally and in the same direction before the actual transfer of the book block 2.

For this purpose, the transfer device 18 comprises an essentially horizontal, roof-like transfer element 21, which is open at the sides and top, and which carries the book block 2 over the vertical distance 22 between the first and second positions 19, 20 of the transfer device 18, i.e., a distance which corresponds at least to the height 16 of the saddle plate 12. The transfer element 21 can be moved vertically under the guidance of a guide arrangement 23 formed out of lifting rods. Other guide arrangements for achieving the vertical parallel displacement of the transfer element 21 can be implemented in the form of spindle gears or other linear drives. At the bottom of the transfer element 21, there is, on each side, a format-variable support element 24 designed as a rail, on which a side portion 25 of the opened book block 2 rests, which ensures optimal transfer of the book block 2 to the saddle plate 12. FIG. 2 shows both the first position 19 and the second position 20 of the transfer device 18, the former on the basis of a support element 24′ illustrated in broken line, the latter on the basis of the support element 24 carrying the book block, illustrated in solid line. In addition, the transfer element 20 comprises, on the side facing the guide arrangement 23, a vertically oriented aligning element 26 for aligning the book block 2 accepted from the first feeder 8. The aligning element 26 is designed as a stop for the front edge of the book block 2. A pusher (not shown), acting on the rear edge of the book block, for example, can also be used as an aligning element.

In that the transfer device 18 accepts the book block 2 from the first feeder 8, lifts it, and transports it to the endless conveyor 10, the transfer device functions as a connector between the first feeder 8 and the endless conveyor 10. The transfer device 18 is designed to be switched on and off by way of a drive 28 connected to a control unit 27; that is, it can be turned on and off as needed, wherein, in the latter case, no book blocks 2 are supplied to the casing-in machine 1. The feeder 8 for the book blocks 2, the feeder 9 for the book covers 3, and the endless conveyor 10 each comprise their own drives 29, 30, 31, which are connected to the control unit 27. Of course, it is also possible to provide a single drive (not shown) instead of the individual drives 28, 29, 30, 31. It is possible and advantageous to synchronize the transfer device 18 and the endless conveyor 10 of the casing-in machine 1 both mechanically and by means of an electric shaft.

A book block 2 supplied to the casing-in machine 1 in the known manner with its spine 32 facing upward is opened in the middle as it comes from the right by means of an opening device 33, which is designed as a block splitter and which is mounted on the machine frame (not shown) of the casing-in machine 1. The transport of the book block 2 proceeds next by way of an intermediate piece 34, also mounted on the machine frame, and ends upstream of the first feeder 8 at the transfer device 18, i.e., at its transfer element 21, located in the first position 19. On the transfer element 21, the book blocks 2 are aligned by the aligning element 26, so that they have the correct registration.

The saddle plates 12 move around the circuit of the endless conveyor 10 preferably synchronously with the feeding-in of the book blocks 2 by the first feeder 8 and the transfer device 18 and also in synchrony with the supply of the book covers 3 by the second feeder 9. For this purpose, the endless conveyor 10 comprises a first 35 and a second vertical conveying section 36 and an upper 37 and a lower conveying section 38, the two latter sections connecting the first and the second vertical conveying sections 35, 36 together. The first vertical conveying section 35 faces the transfer device 18, whereas the second vertical conveying section 36 faces away from the transfer device 18 (FIG. 2).

Not shown are inventive variants which make it possible to accept book blocks 2 from other directions different from the feed direction 7 of the book covers 3, such as from the side.

By means of a vertical stroke of the transfer element 21 synchronized with the endless conveyor 10, the book block 2 is carried from the first position 19 to the second position 20 of the transfer device 18. Traveling horizontally, the associated saddle plate 12 of the endless conveyor 10 moves sideways into the transfer element 21 and thus into the book block 2, which is being held open by the transfer element 21, and picks it up during its subsequent vertical upward movement, the book block thus resting astride its spine 15. The handing-over of the book block 2 from the transfer device 18 thus takes place along the first vertical conveying section 35 of the endless conveyor 10.

The distance by which the transfer element 21 travels upward should be at least great enough that the saddle plate is already starting to travel vertically upward when it picks up the book block 2, thus ensuring a precise fit and eliminating the danger of lateral displacement.

While the transfer device 18 and its transfer element 21 are returning to the first position 19, the book block 2 which has just been handed over to the saddle plate 12 of the endless conveyor 10 is guided through a gluing unit 40, equipped with glue applicator rolls 39. This is followed by the known processing steps (not shown) of the casing-in machine 1, such as the placement of the book cover 3 and the pressing of the cover onto the book block 2. During the downward movement of the saddle plate 12 in the second vertical conveying section 36, finally, the book 41 produced in the manner described is removed from the saddle plate 12 in a manner known in itself and therefore not discussed here by hold-back elements and then set down to the side.

The distance between the two glue applicator rolls 39 is advantageous adjustable by means of an actuating device (not shown). Alternatively, the glue applicator rolls 39 can also be spring-loaded, of course. As the book blocks 2 are passing through the gluing unit 40, it is therefore possible for the glue applicator rolls 39 to compensate for the thickness differences within this book block 2 caused by the difference between the lesser height 16 of the saddle plate 12 and the greater height of the associated book block 2.

The arrangement of the endless conveyor 10 completely above the area where the book blocks 2 are supplied by the first feeder 8 means that, at approximately the same output and same format specifications, the number of saddle plates 12 on the endless conveyor 10 and the length of the double drive chain 14 and of the control chain 14′ can be decreased. The reduced overall length of the endless conveyor 10 is associated with corresponding cost savings.

Because of the use of the transfer device 18 to connect the book block transport means to the endless conveyor 10, it is very easy, in another embodiment of the inventive casing-in machine 1, to stop a book block from being transferred to the endless conveyor 10 and to eject it automatically in the event of a defect.

While specific embodiments of the invention have been shown and described in detail to illustrate the inventive principles, it will be understood that the invention may be embodied otherwise without departing from such principle.

I claim:

1. A method for casing a book block in a book cover, comprising the steps of
supplying the book block with an upward facing, horizontally oriented spine to a casing-in machine in a first direction;
transferring the book block to the casing-in machine via a saddle plate of an endless conveyor, the saddle plate comprising an upward-facing, horizontally oriented spine;
gluing the book block transported on the saddle plate;
supplying the book cover to the casing-in machine in a second direction;
casing the book block in the book cover while maintaining the horizontal orientation of the spine of the saddle plate, wherein the supplying of the book block to the casing-in machine takes place in a first feed direction different from a second feed direction of the book cover, wherein, in a first step, the book block is transferred from a first feeder to a transfer device located in a first, upstream position, in a second step the book block is transported from the first position second, downstream position of the transfer device, and, in a third step, the book block is accepted by the saddle plate of the endless conveyor from the second position of the transfer device.

2. The method according to claim 1, including transporting the book block in an area underneath the endless conveyor to the first, upstream position of the transfer device.

3. The method according to claim 1, including lifting the book block, as the book block is being transported from the first, upstream position into the second, downstream position of the transfer device.

4. The method according to claim 3, including aligning the book block before the book block is lifted.

5. The method according to claim 1, including opening the book block before the book block reaches the first, upstream position.

6. The method according to claim 5, including transporting the book block from the first, upstream position to the second, downstream position of the transfer device in an opened state, and while the opened book block is in the second position, introducing the saddle plate of the endless conveyor into the open book from a side at least substantially horizontally and picking up the book block with a substantially vertical movement.

7. The method according to claim 1, wherein the saddle plate travels around a circuit in the manner of a continuous elevator.

8. A casing-in machine for casing a book block in a book cover, comprising:
an endless conveyor having at least one saddle plate, on which casing of the book block in the book cover takes place, the at least one saddle plate having an upward facing, horizontally oriented spine;
a first feeder for supplying the book block with an upward-facing, horizontally oriented spine to the casing-in machine in a first feed direction;
a second feeder for supplying the book cover to the casing-in machine in a second feed direction, the first feed direction differing from the second feed direction;
and a transfer device arranged between the first feeder and the endless conveyor.

9. The casing-in machine according to claim 8, wherein the transfer device comprises a first, upstream position for accepting the book block from the first feeder and a second, downstream position for transferring the book block to the endless conveyor.

10. The casing-in machine according to claim 8, wherein the transfer device is designed to be switchable on and off.

11. The casing-in machine according to claim 8, wherein the transfer device comprises a roof-like transfer element, which is open at a side and top, for accepting the book block.

12. The casing-in machine according to claim 8, wherein the transfer device comprises at least one aligning element for the book block.

13. The casing-in machine according to claim 8, wherein the transfer device comprises format-dependent support elements for the book block.

14. The casing-in machine according to claim 8, wherein the first feeder is arranged underneath the endless conveyor.

15. The casing-in machine according to claim 14, wherein the transfer element is movable in a vertical direction.

16. The casing-in machine according to claim 8, and further comprising an opening device for the book block arranged in, on, or upstream of the first feeder.

17. The casing-in machine according to claim 8, wherein the endless conveyor comprises first and second vertical conveying sections and upper and lower conveying sections that connect the first and second vertical conveying sections together, wherein the first vertical conveying section faces the transfer device and the second vertical conveying section faces away from the transfer device.

18. The casing-in machine according to claim 8, wherein the transfer device, the first and second feeders, and the endless conveyor each have their own separate drives, wherein the drives are connected to each other.

19. The according to claim 8, wherein the at least one saddle plate has a height that is less than a maximum processable height of the book block.

20. The casing-in machine according to claim 19, wherein the height of the at least one saddle plate is substantially equal to one-third of the maximum possible height of the book block.

21. The casing-in machine according to claim 8, wherein the first feed direction is opposite the second feed direction.

22. A book line comprising a casing-in machine according to claim 8.
